(19) United States
(12) Patent Application Publication
(10) Pub. No.: US 2006/0262951 A1
(43) Pub. Date: Nov. 23, 2006

(54) Apparatus for generating magnetic field for the hearing impaired in portable communication terminal

(75) Inventor: Jong-Nam Jun, Seoul (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/439,314

(22) Filed: May 23, 2006

(30) Foreign Application Priority Data
May 23, 2005 (KR) 2005-0042832

(51) Int. Cl. H04R 25/00

(52) U.S. Cl. 381/312

(57) ABSTRACT

An apparatus for generating a magnetic field in a portable communication terminal for the hearing impaired. The apparatus includes an amplifier for amplifying an electric signal of a voice band from a codec to a predetermined level, a Low Pass Filter (LPF) for removing harmonic components from an output electric signal of the amplifier, and a coil for converting an output electric signal of the LPF into a magnetic signal. Accordingly, the apparatus for generating the magnetic field can be implemented using the Class-D audio amp. Also, the efficiency of the apparatus for generating the magnetic field can be improved, while reducing its size.

### PRIORITY

This application claims priority under 35 U.S.C. § 119 to an application entitled “Apparatus For Generating Magnetic Field For The Hearing Impaired in Portable Communication Terminal” filed in the Korean Intellectual Property Office on May 23, 2005 and assigned Serial No. 2005-42832, the contents of which are incorporated herein by reference.

### BACKGROUND OF THE INVENTION

1. Field of the Invention

The present invention relates generally to a portable communication terminal for the hearing impaired, and in particular, to an apparatus for generating a magnetic field using a Class-D audio amp.

2. Description of the Related Art

The advent of the CD in the early 1980s signaled the beginning of a digital revolution in audio. As the digital audio evolved, digital audio sources such as MP3, DVD, and the like are becoming mainstream. In addition, developments for higher resolution and fidelity have been continuously in progress.

Until recently, amplifiers have stuck to the analog system. However, since analog amplifiers operate in a linear region of a transistor, the loss of the transistor itself corresponding to the product of a voltage and a current occurs inevitably. Consequently, a lot of loss due to heat is caused. Therefore, with the development of the sampling and filter technology, digital amplifiers with high power and high efficiency are considered as the most efficient amplifier.

The digital amplifier is a device for amplifying digital signal, that is, a pulse signal. While the analog amplifier amplifies a continuous sinusoidal wave, the digital amplifier changes a two-state signal of “0” and “1” or “on” and “off” into a signal with an increased strength.

The digital amplifier compares an external input signal with an internal triangular wave. The digital amplifier outputs “HGH (ON)” when the external input signal is higher than the triangular wave, while it outputs “LOW (OFF)” when the external input signal is lower than the triangular wave. The resulting output waveform becomes a square wave having a width proportional to the intensity of the input signal. The square wave is called a Pulse Width Modulation (PWM) waveform. The digital amplifier switches the PWM waveform by means of a high-power transistor, thus generating a PWM waveform with large amplitude. Such an amplifier is called a Class-D amplifier.

The digital amplifier has an advantage in that the transistor is switched without being used in the linear region. Therefore, as compared with the analog amplifier, the loss due to the heat of the transistor is much less and thus the digital amplifier has a very high efficiency of about 95%. As a result of the digital amplifier being smaller in size than the analog amplifier, it can obtain higher power. Under the same power, the digital amplifier has more than three times power efficiency than the analog amplifier and its size can be reduced by less than half.

The continuous growth and development of electronic and communication industries have resulted in the mainstream use of the portable communication terminals and the functions of the portable communication terminals are being diversified to satisfy users' demand. For example, in addition to the simple telephone functions, users can now use the portable communication terminals to download and play music files and/or to download video on demand (VOD) files as well as view moving pictures. Also, users can use the portable communication terminal to take a picture of an object and store it in an album or the like. Like this, numerous functions are being added to portable communication terminals. Notwithstanding, the tendency is that portable communication terminals are decreasing in size.

Cellular phone makers will be obliged to produce portable communication terminals for the hearing impaired. The Radio Frequency (RF) emission of the digital mobile phones causing malfunction of a hearing aid is not yet regulated. However, the United States Federal Communications Commissions (FCC) has unanimously voted that half of all digital mobile phone models must be compliant with reduced Radio Frequency (RF) emission requirements by Feb. 18, 2008.

The hearing aid uses a TeleCoil (T-Coil) to amplify voice signals of a cellular phone or receives a magnetic signal from a telephone that generates a clearer voice signal than the cellular phone. The United States Code requires that most wired telephones should be compatible with hearing aids. A newly enacted law requires that in two years, cellular phone makers produce at least two models that do not obstruct hearing aids. Additionally, in three years cellular phone makers have to develop a new model cellular phone with a T-coil.

The T-coil generates a sufficient magnetic field toward an induction coil of a hearing aid. The use of the T-Coil can prevent feedback (e.g., whistle) generated when the microphone of the hearing aid is enclosed, just like when the telephone encloses the hearing aid. Consequently, more clear tone quality can be provided. Generally, a coil installed in the hearing aid to receive a magnetic field is also called a T-Coil. Hereinafter, the term “T-Coil” is used to refer to the coil installed in the portable communication terminal to generate a magnetic field.

FIGS. 1 and 2 are schematic diagrams of conventional apparatuses for generating a magnetic field in a portable communication terminal for the hearing impaired.

Referring to FIG. 1, a speaker 105 is an amplifier with an impedance of several to several ten ohms. The speaker 105 receives an electric signal 100 of a voice band from a codec and converts it into an audio signal that is recognizable to the ears of a normal person. At this point, the normal person listens to the outputted audio from the speaker 105.

Simultaneously, an audio amplifier 101 amplifies the electric signal 100 of the voice band from the codec to a predetermined level. Resistors R1 and R2 connected to input terminals of the audio amplifier 101 are provided for determining an amplification level of the audio amplifier 101. A T-Coil 103 has several hundred to several ten thousand ohms in compliance with the Hearing Aid Compatibility (HAC) Act. The T-Coil 103 converts the electric signal from the audio amplifier 101 into a magnetic signal. At this point, the magnetic signal generated from the T-Coil 103 drives a hearing aid (not shown) that a hearing impaired person wears. It is preferable that the T-Coil 103 should be located in a location adjacent to the speaker 105 so as to generate a magnetic field towards the user's ears (or the hearing aid). Although the concurrent operation of the speaker 105 and the T-Coil 103 has been described above, however, only one can be driven by the user's setting.

Referring to FIG. 2, an audio amplifier 201 amplifies an electric signal 200 of a voice band from a codec to a predetermined level. A T-Coil 203 has several hundred to several ten thousand ohms in compliance with HAC Act. The T-Coil 203 converts the electric signal from the audio amplifier 201 into magnetic signal. At this point, the magnetic signal generated from the T-coil 203 drives a hearing aid (not shown) that a hearing impaired person wears. It is preferable that the T-Coil 203 should be located in a location adjacent to a speaker 207 so as to generate a magnetic field toward the user's ears (or the hearing aid).

An attenuator 205 is constructed with resistors R3 and R4 and attenuates the signal from the audio amplifier 201 to a predetermined level so as to apply the signal to the speaker 207 having an impedance of several to several ten ohms. The speaker 207 converts the electric signal from the attenuator 205 into an audio signal that is recognizable to the ears of a normal person. At this point, the normal person listens to the outputted audio from the speaker 207. Although the concurrent operation of the speaker 207 and the T-Coil 203 has been described above, however, only one can be driven by the user's setting

According to the prior art, it is possible to implement the HAC function by using the Class-D amplifier. The signal (e.g., a PWM signal etc.) amplified by the Class-D amplifier is changed into an RF signal of a several hundred KHz band. When the RF signal is applied to the T-Coil so as to implement the HAC function, it is impossible to generate a magnetic field of a voice frequency band at which the hearing aid for the hearing impaired can be driven. Accordingly, the existing HAC function can be implemented using a Class-A or Class-AB audio amplifier. The Class-D amplifier having much a higher efficiency than the Class-A or Class-AB audio amplifier can implement only a phone call function by connecting a speaker to an output terminal. Also, when the HAC function is implemented using the Class-A or Class-AB audio amplifier, an analog signal passing through a filter is applied to both the speaker and the T-coil, thereby reducing the efficiency.

### SUMMARY OF THE INVENTION

The present invention provides a portable communication terminal for the hearing impaired.

The present invention also provides an apparatus for generating a magnetic field using a Class-D audio amplifier.

Further, the present invention provides an apparatus for generating a magnetic field with high efficiency.

According to an aspect of the present invention, there is provided an apparatus for generating a magnetic field in a portable communication terminal for a hearing impaired person, the apparatus includes a speaker for converting an electric signal of a voice band into an audio signal; an amplifier for amplifying the electric signal of the voice band to a predetermined level; a low pass filter (LPF) for removing harmonic components from an output electric signal of the amplifier; and a T-Coil for converting an output electric signal of the LPF into a magnetic signal.

According to another embodiment of the present invention, there is provided an apparatus for generating a magnetic field in a portable communication terminal for a hearing impaired person, the apparatus includes an amplifier for amplifying an electric signal of a voice band to a predetermined level; a low pass filter (LPF) for removing harmonic components from an output electric signal of the amplifier; a T-coil for converting an output electric signal of the LPF into a magnetic signal; an attenuator for attenuating the amplified electric signal to a predetermined level; and a speaker for converting the attenuated electric signal into an audio signal.

### BRIEF DESCRIPTION OF THE DRAWINGS

The above and other objects, features and advantages of the present invention will become more apparent from the following detailed description when taken in conjunction with the accompanying drawings, in which:

FIG. 1 is a schematic diagram of a conventional apparatus for generating a magnetic field in a portable communication terminal for the hearing impaired;

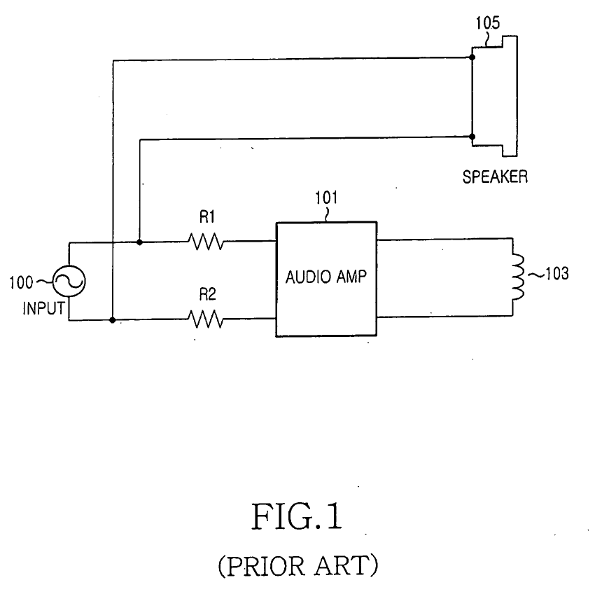

FIG. 2 is a schematic diagram of another conventional apparatus for generating a magnetic field in a portable communication terminal for the hearing impaired;

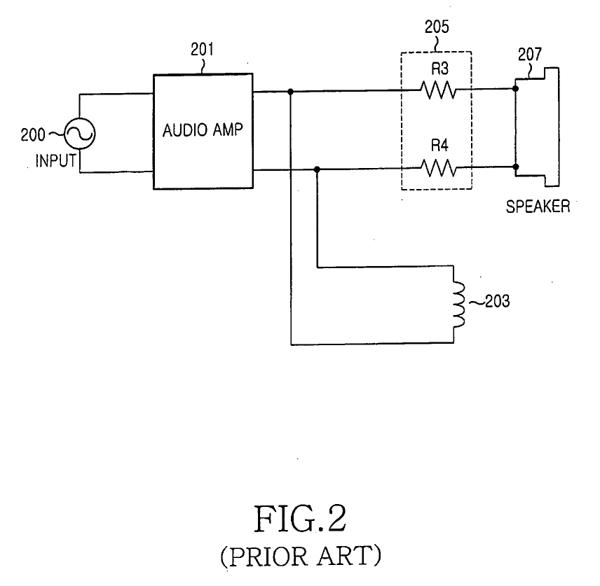

FIG. 3 is a block diagram schematically illustrating a portable communication terminal for the hearing impaired according to the present invention;

FIG. 4 is a schematic diagram of a HAC unit illustrated in FIG. 3;

FIG. 5 is a schematic diagram of an apparatus for generating a magnetic field in a portable communication terminal for the hearing impaired according to a first embodiment of the present invention; and

FIG. 6 is a schematic diagram of an apparatus for generating a magnetic field in a portable communication terminal for the hearing impaired according to a second embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Like reference numerals in the drawings denote like elements, and thus their description will be omitted. A detail description of well-known features will be omitted for conciseness.

Hereinafter, a portable communication terminal having an apparatus for generating a magnetic field to a hearing aid for the hearing impaired by using a Class-D audio amplifier will be described in detail with reference to the accompanying drawings.

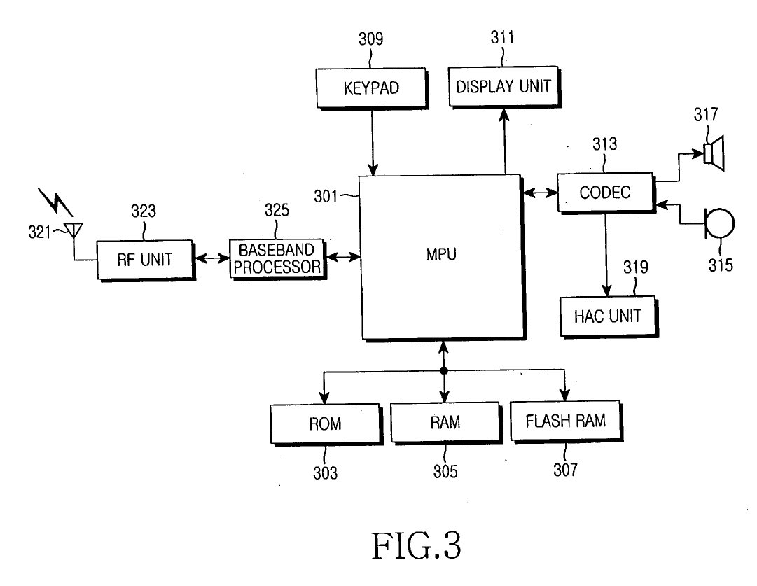

FIG. 3 is a block diagram schematically illustrating a portable communication terminal for the hearing impaired according to the present invention. Examples of the portable communication terminal are a cellular phone, a Personal Communication Service (PCS) terminal, an International Mobile Communication-2000 (IMT2000) terminal, and a 4G (OFDM: Orthogonal Frequency Division Multiplexing) terminal. Following is a description of a general structure of the terminals.

Referring to FIG. 3, a microprocessor unit (MPU) 301 controls an overall operation of the portable communication terminal. For example, the MPU 200 processes and controls a voice communication and a data communication. A detail description about typical process and control operations of the MPU 301 will be omitted.

A Read Only Memory (ROM) 303 stores microcodes of a program for controlling the MPU 301 and a variety of reference data. A Random Access Memory (RAM) 305 is a working memory of the MPU 301 and temporarily stores data that are generated during the execution of the program. A Flash RAM 307 stores a variety of updateable data.

A keypad 309 includes numeric keys of digits 0-9 and a plurality of function keys, such as a Menu key, a Cancel (Delete) key, a Conformation key, a Talk key, an End key, an Internet connection key, and Navigational keys (▴/▾/≮/≯). Upon pressing a key on the keypad 309, a corresponding key input data is provided to the MPU 301. Specifically, when a key is pressed according to the present invention, an electric signal identifying a position of the pressed key is generated to the MPU 301. A display unit 311 displays including but not limited to numerals and characters, moving pictures and still pictures. A color Liquid Crystal Display (LCD) may be used for the display unit 311.

A coder-decoder (codec) 313 connected to the MPU 301, and a speaker 317 and a microphone 315 connected to the codec 313 serve as an audio input/output block for a telephone communication and voice recording. The codec 313 converts digital data from the MPU 301 into analog audio signals and outputs the analog audio signals through the speaker 317. Also, the codec 313 converts audio signals received through the microphone 315 into digital data and provides the digital data to the MPU 301.

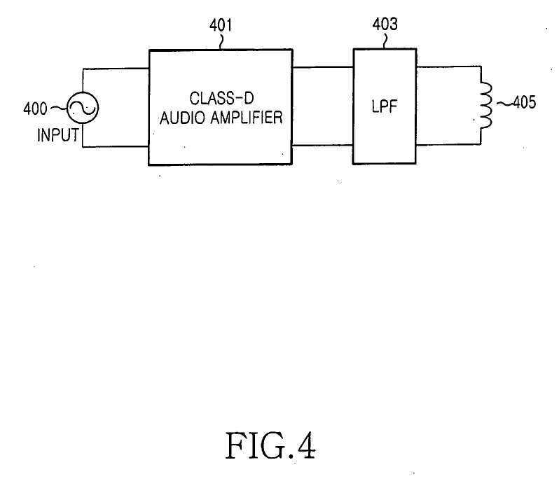

An HAC unit 319 includes a T-Coil for generating a sufficient magnetic field to a hearing aid (not shown) and converts the analog signal from the codec 313 into magnetic signal. The converted magnetic signal is transmitted to an induction coil of the hearing aid that a hearing impaired person wears. A detailed structure of the HAC unit 319 will be described later in detail with reference to FIGS. 4 to 6.

A Radio Frequency (RF) unit 323 down-converts a frequency of an RF signal received through an antenna 321 and provides the down-converted RF signal to a baseband processor 325. Also, the RF unit 323 up-converts the frequency of a baseband signal provided from the baseband processor 325 and transmits the up-converted baseband signal through the antenna 321. The baseband processor 325 processes the baseband signals that are transmitted/received between the RF unit 323 and the MPU 301. For example, upon a transmission operation, the RF unit 323 performs a channel coding and spreading of data to be transmitted. Upon a reception operation, the RF unit 323 performs a despreading and a channel decoding of the received signal

FIG. 4 is a schematic diagram of the HAC unit 319 illustrated in FIG. 3.

Referring to FIG. 4, the HAC unit 319 includes a Class-D audio amplifier 401, a Low Pass Filter (LPF) 403, and a T-Coil 405 with an impedance of several hundred to several ten thousand ohms. Although the HAC unit 319 is constructed on the assumption that the codec 313 generates a differential signal, the HAC unit 319 will have the same structure when the codec 313 generates a single signal.

The Class-D audio amplifier 401 amplifies an analog electric signal from the codec 313 and outputs a digital electric signal with a predetermined amplified level. The LPF 403 removes unnecessary harmonic components from the amplified digital electric signal and outputs analog signal to the T-Coil 405. The T-Coil 405 converts the electric signal from the LPF 403 into a magnetic signal of a voice frequency band. In this way, the hearing aid for the hearing impaired can be driven. The reason for amplifying the output signal of the codec 313 is that the output signal of the codec 313 is a small-level signal matched with a small-sized speaker having an impedance of several ten ohms and thus a sufficient magnetic field cannot be generated using this small-level signal.

A connection relationship of a codec, a HAC unit, and a speaker will be described in detail below.

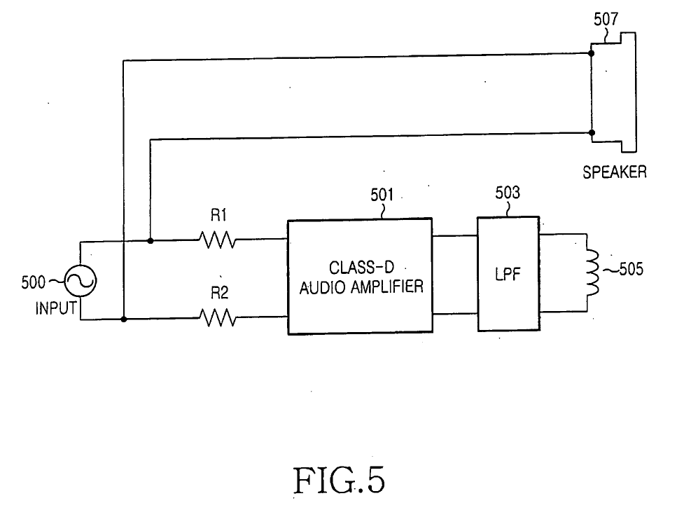

FIG. 5 is a schematic diagram of an apparatus for generating a magnetic field in the portable communication terminal for the hearing impaired according to the present invention.

Referring to FIG. 5, a speaker 507 is an amplifier with an impedance of several to several ten ohms. The speaker 507 receives an electric signal 500 of a voice band from the codec 313 and converts it into an audio signal that is recognizable to the ears of a person who is not hearing impaired. At this point, the normal person listens to the audio outputted from the speaker 507.

Simultaneously, a Class-D audio amplifier 501 amplifies the electric signal 500 of the voice band from the codec 313 to a predetermined level. Resistors R1 and R2 connected to input terminals of the audio amplifier 501 are provided for determining an amplification level of the audio amplifier 501. An LPF 503 removes harmonic components from the amplified digital electric signal of the audio amplifier 501 and outputs analog signal to a T-Coil 505. The T-coil 505 has several hundred to several ten thousand ohms in compliance with HAC Act. The T-Coil 505 converts the electric signal from the LPF 501 into a magnetic signal. At this point, the magnetic signal generated from the T-Coil 505 drives a hearing aid (not shown) that a hearing impaired person wears. It is preferable that the T-Coil 505 should be located in a proper place adjacent to the speaker 507 so as to generate the magnetic field towards the user's ears (or the hearing aid). Although the concurrent operation of the speaker 507 and the T-Coil 505 has been described above, however only one can be driven by the user's setting.

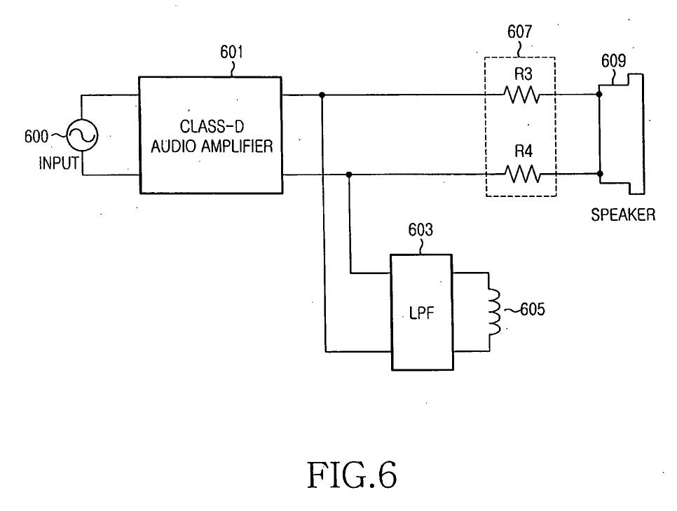

FIG. 6 is a schematic diagram of an apparatus for generating a magnetic field in the portable communication terminal for the hearing impaired according to the present invention.

Referring to FIG. 6, an audio amplifier 601 amplifies an electric signal of a voice band from the codec 313 to a predetermined level, and outputs a digital electric signal. An LPF 603 removes harmonic components from the amplified digital electric signal of the audio amplifier 601 and outputs analog signal to a T-Coil 605. The T-Coil 605 has several hundred to several ten thousand ohms in compliance with the HAC Act. The T-Coil 605 converts the electric signal from the audio amplifier 601 into a magnetic signal. At this point, the magnetic signal generated from the T-Coil 605 drives a hearing aid (not shown) that a hearing impaired person wears. It is preferable that the T-Coil 505 should be located in a location adjacent to the speaker 609 so as to generate the magnetic field towards the user's ears (or the hearing aid).

An attenuator 607 is constructed with resistors R3 and R4 and attenuates the digital signal from the Class-D audio amplifier 601 to a predetermined level so as to apply the signal to the speaker 609 having an impedance of several to several ten ohms. The speaker 609 converts the electric signal from the attenuator 607 into an audio signal that is recognizable to the ears of a normal person. Although the concurrent operation of the speaker 609 and the T-Coil 605 has been described above, however only one can be driven by the user's setting.

As described above, in the portable communication terminal, the apparatus for generating the magnetic field to a hearing aid for the hearing impaired can be implemented using the Class-D audio amplifier by further providing the LPF for removing harmonic components of the signal. Also, the efficiency of the apparatus for generating the magnetic field can be improved, while reducing its size.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. An apparatus for generating a magnetic field in a portable communication terminal for a hearing impaired person, the apparatus comprising:
an amplifier for amplifying an electric signal of a voice band from a codec to a predetermined level;
a Low Pass Filter (LPF) for removing harmonic components from an output electric signal of the amplifier; and
a coil for converting an output electric signal of the LPF into a magnetic signal.

2. The apparatus of claim 1, wherein the amplifier is a Class-D audio amplifier.

3. The apparatus of claim 1, wherein the LPF is a voice-band pass filter.

4. The apparatus of claim 1, wherein the coil is a TeleCoil (T-Coil) with an impedance of several hundred to several thousand ohms in compliance with the Hearing Aid Compatibility (HAC) Act.

5. The apparatus of claim 1, further comprising a speaker with an impedance of several to several ten ohms for converting the electric signal of the voice band from the codec into a video signal for a person who is not hearing impaired.

6. The apparatus of claim 1, further comprising:
an attenuator for attenuating the amplified electric signal to a predetermined level; and
a speaker with an impedance of several to several ten ohms for converting the attenuated electric signal into an audio signal for a person who is not hearing impaired.

7. A portable terminal including an apparatus for generating a magnetic field to hearing aid for a hearing impaired person, the portable terminal comprising:
an amplifier for amplifying an electric signal of a voice band from a codec;
a filter for removing harmonic components from an output electric signal of the amplifier; and
a coil for converting an output electric signal from the filter into a magnetic signal.

8. The portable terminal of claim 7, wherein the amplifier is a Class-D audio amplifier.

9. The apparatus of claim 7, wherein the filter is a voice-band pass filter.

10. The apparatus of claim 7, wherein the coil is a TeleCoil (T-Coil) with an impedance of several hundred to several thousand ohms in compliance with Hearing Aid Compatibility (HAC) Act.

11. The apparatus of claim 7, further comprising a speaker for converting the electric signal of the voice band from the codec into a video signal for a person who is not hearing impaired.

12. The apparatus of claim 11, wherein the speaker has an impedance of several to several ten ohms.

13. The apparatus of claim 7, further comprising:
an attenuator for attenuating the amplified electric signal to a predetermined level; and
a speaker with an impedance of several to several ten ohms for converting the attenuated electric signal into an audio signal for a person who is not hearing impaired.

14. The apparatus of claim 13, wherein the speaker has an impedance of several to several ten ohms.

15. The apparatus of claim 1, wherein the filter is a low pass filter.
